(19) United States
(12) Patent Application Publication
(10) Pub. No.: US 2015/0145624 A1
(43) Pub. Date: May 28, 2015

(54) ELECTROMAGNETIC MOTOR AND OTHER ELECTROMAGNETIC DEVICES WITH INTEGRATED COOLING

(71) Applicant: WEINBERG MEDICAL PHYSICS LLC, Bethesda, MD (US)

(72) Inventor: Irving N. WEINBERG, Bethesda, MD (US)

(21) Appl. No.: 14/614,592

(22) Filed: Feb. 5, 2015

Related U.S. Application Data
(63) Continuation-in-part of application No. 13/242,386, filed on Sep. 23, 2011.
(60) Provisional application No. 61/935,939, filed on Feb. 5, 2014.
(60) Provisional application No. 61/451,978, filed on Mar. 11, 2011.
(60) Provisional application No. 61/385,662, filed on Sep. 23, 2010.

(51) Int. Cl. H01F 27/10; H01F 7/06; H01F 5/00

(52) U.S. Cl. CPC H01F 27/105; H01F 5/00; H01F 7/06
USPC 335/296; 174/16.1

(57) ABSTRACT

An apparatus, and method of constructing such an apparatus, conducts and insulates materials with intervening coolant channels, wherein the conducting materials form an electromagnet.

### PRIORITY CLAIMS

This patent application claims priority to U.S. Provisional Patent Application No. 61/935,939, filed Feb. 5, 2014, entitled “ELECTROMAGNETIC MOTOR AND OTHER ELECTROMAGNETIC DEVICES WITH INTEGRATED GAS COOLING,” and U.S. patent application Ser. No. 13/242,386, filed Sep. 23, 2011, entitled “FLEXIBLE METHODS OF FABRICATING ELECTROMAGNETS AND RESULTING ELECTROMAGNET ELEMENTS,” which claims priority to U.S. Provisional Patent Application Nos. 61/451,978, filed Mar. 11, 2011, and 61/385,662, filed Sep. 23, 2010, the disclosures of which are incorporated herein by reference in their entirety.

### FIELD OF INVENTION

Disclosed embodiments are directed to the field of electromagnetic devices for generation of magnetic fields, transport, electrical energy, or other applications.

### BACKGROUND

This invention incorporates material first disclosed by I. N. Weinberg et al in U.S. application Ser. No. 13/242,386, entitled “Flexible methods of fabricating electromagnets and resulting electromagnet elements”. In that disclosure, coolant channels were fabricated as part of an electromagnetic coil, with micro-channel fractal cooling networks as an example of one possible configuration of the coolant channels.

It is known that cooling of conductors results in lowered resistance to electrical current. The temperature dependence is given by the formula

(R−R0)/R0=alpha*(T−T0),

where R0 is the initial resistance at temperature T0, R is the new resistance at temperature T, and alpha for copper is about 0.004/degree Centigrade. Thus a 2-ohm copper coil at room temperature will have a resistance reduced almost ten-fold (i.e., to 0.25 ohms) at 77-degrees-Kelvin, the temperature of liquid nitrogen. Most superconductors must first be quenched in order to reverse polarity, as shown in the 2008 article by S. A. March et al entitled “Towards the design of power switches utilizing HTS material”(the disclosure of which is incorporated by reference in its entirety), in the Journal of Physics Conference Series vol. 97, 012002. Unlike most superconductors, copper cooled to low temperatures (e.g., 77-degrees Kelvin) is still able to tolerate rapid changes in current direction and magnitude, as is needed in some motors and other electrical and electromagnetic devices.

An example of the use of rapidly-switched electromagnetic devices is the use of magnetic gradient coils for magnetic imaging of the human body that change current polarity too fast to cause unpleasant nerve stimulation. This clinical application is described in U.S. Pat. No. 8,466,680, entitled “Apparatus and method for decreasing bio-effects of magnetic gradient fields”, by I. Weinberg and P. Stepanov (the disclosure of which is incorporated by reference in its entirety). For the purpose of this invention, the term magnetic imaging is used to refer to magnetic resonance imaging (whether of protons, electrons, or other species), or other forms of imaging that employ magnetic fields (e.g., magnetic particle imaging).

Lowered resistance is a critical factor in the efficiency of motors and other electromagnetic devices, as discussed in the scientific article by D. T. Peters, E. F. Brush, Jr. and J. L. Kirtley, Jr., entitled “Die-Cast Copper Rotors as Strategy for Improving Induction Motor Efficiency” (the disclosure of which is incorporated by reference in its entirety), published in the Proceedings of the 2007 IEEE Electrical Insulation Conference and Electrical Manufacturing Expo, pages 322-327.

Expanding gases can be used to cool materials, via the Joule-Thompson principle, as described in the 2005 scientific article by Y-J Hong et al, entitled “The Performance of Joule Thompson Refrigerator” published in the journal Cryocoolers, vol. 13, pages 497-502, and the 1984 patent application CA1199190 by William A. Little, entitled “Fast cooldown miniature refrigerators” (the disclosure of which is incorporated by reference in its entirety). In the Little invention, micron-sized channels bring gas into an expansion chamber, and are arrayed so that a counter-cooling flow can precool gas coming into the chamber.

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

Disclosed embodiments provide an apparatus, and a method of constructing such an apparatus, that conducts and insulates materials with intervening coolant channels.

In accordance with disclosed embodiments, the conducting materials may form an electromagnet.

In accordance with disclosed embodiments, gas can travel through at least some of the coolant channels and expand as it travels through these and other coolant channels.

In accordance with disclosed embodiments, the coolant channels may be arrayed in a counter-cooling pattern to pre-cool gas that enters the electromagnet.

### BRIEF DESCRIPTION OF THE FIGURES

A more complete understanding of the present invention and the utility thereof may be acquired by referring to the following description in consideration of the accompanying drawings, in which like reference numbers indicate like features, and wherein:

FIG. 1 is an illustration of a small-cross section of a larger three-dimensional device provided in accordance with a disclosed embodiment.

FIG. 2 is an illustration of a small-cross section of a larger three-dimensional device provided in accordance with another disclosed embodiment.

### DETAILED DESCRIPTION

The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

In the following description of various embodiments, reference is made to the accompanying drawings, which form a part hereof, and in which is shown, by way of illustration, various embodiments in which the invention may be practiced. It is to be understood that other embodiments may be utilized and structural and functional modifications may be made without departing from the scope and spirit of the present invention.

Moreover, it should be understood that various connections are set forth between elements in the following description; however, these connections in general, and, unless otherwise specified, may be either direct or indirect, either permanent or transitory, and either dedicated or shared, and that this specification is not intended to be limiting in this respect.

The disclosed embodiments provide an apparatus (and a method of constructing said apparatus) comprising conducting and insulating materials with intervening coolant channels, whereby the conducting materials form an electromagnet, and gas can travel through some of the coolant channels and expand as it travels through these and other coolant channels. The coolant channels may be arrayed in a counter-cooling pattern as in Little, in order to pre-cool gas that enters the electromagnet.

For the purposes of this disclosure, the term electromagnet is broadly used, and is intended to include any device in which magnetic fields arise as a result of electrical currents. Specifically, application to any motors, transformers, magnetic gradient generators, induction heaters, coils to create and manipulate plasma, coil actuators, magnetic levitation systems, and electrical generators that contain conductors in which electrical currents flow are included in the term “electromagnet”. The expansion of the gas in the coolant channels results in cooling of the electromagnet so that the resistance of the electromagnet is reduced, thereby increasing overall efficiency of the electromagnet. If the electromagnet is part of a motor, then the motor's efficiency is also increased.

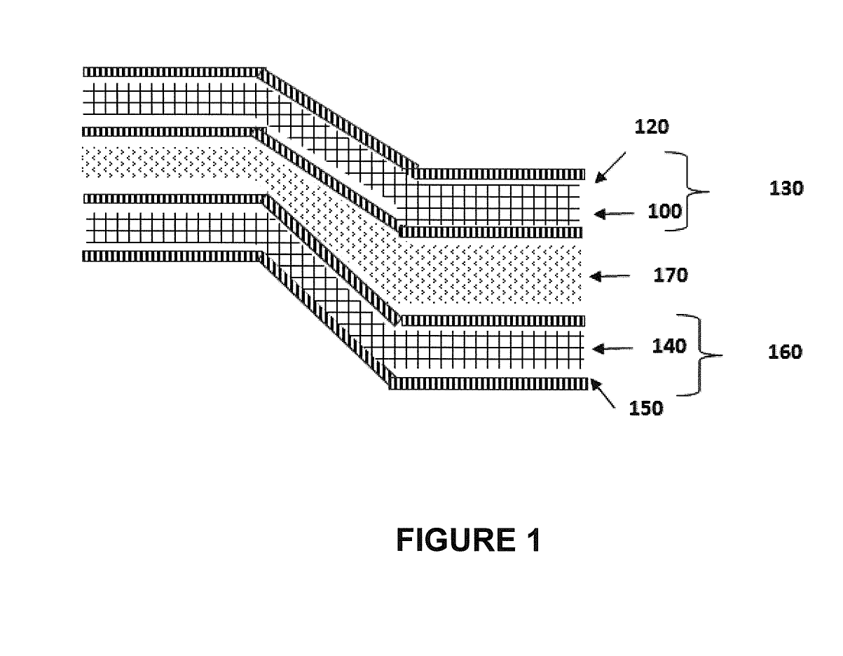

FIG. 1 illustrates an example of the disclosed embodiments. The figure is two-dimensional but is intended to represent a small-cross section of a larger three-dimensional device. Conducting path 100 is surrounded in part by insulating layer 120, thereby comprising an insulated conducting path 130. Similarly, conducting path 140 is surrounded in part by Insulating layer 150, thereby comprising an insulated conducting path 160. Gas-filled channel 170 exists between 130 and 160. The expansion of gas in channel 170 cools conducting paths 100 and 140 in order to decrease resistance and thereby increase efficiency of the electromagnetic device comprised of many such segments.

Although FIG. 1 shows the gas-filled channel 170 having an expanding area, some or all of the channels in the device may be of non-expanding cross-section. As the gas travels through the channels it will expand and cool nearby conducting paths. Counter-current gas channels are not shown in FIG. 1 but can be included in the device to increase cooling efficiency.

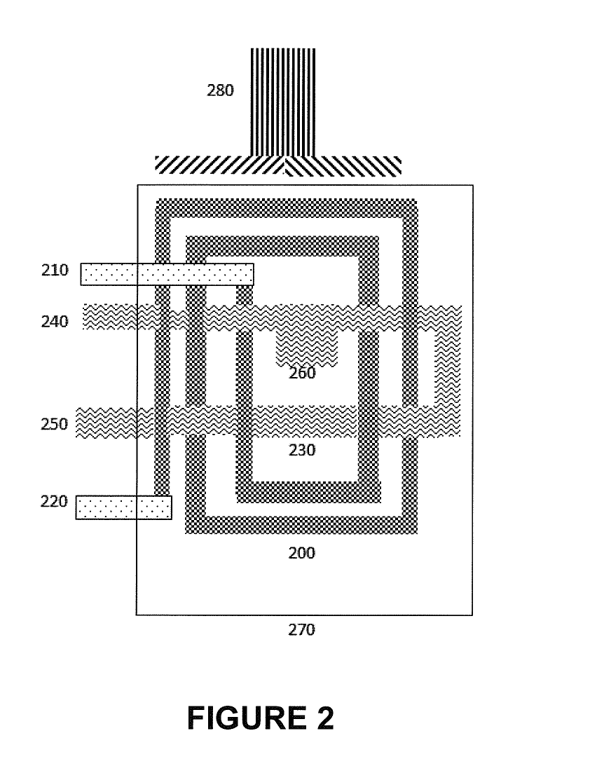

FIG. 2 shows another example of the disclosed embodiments. An electromagnetic coil 200 may be activated via contacts 210 and 220. Coolant (for example, liquid nitrogen) may be introduced to cooling channel 230 (which interleaves with electromagnet coil 200) via inlet 240 and removed by outlet 250 by a compressor (not shown). Alternatively, dry nitrogen could be introduced via inlet 240 and liquefied within the region 260, which may contain expanding and shrinking portions as needed to remove heat from the coolant. The electromagnet may be contained within container 270, which may have a vacuum wall as is typical for a cryogenic storage Dewar. Electromagnetic energy may be converted to kinetic energy and transmitted to wheels via magnetic gear 280, which does not need to contact coil 200. It should be understood that the conductive paths of electromagnet 200 may interleave with each other in order to reduce resistance at high frequencies due to the skin effect, as may be done with Litz wires. It should be understood that the apparatus may be constructed wholly or in part using additive manufacturing techniques, as in the prior invention by Weinberg entitled “Flexible Methods of Fabricating Electromagnets”, submitted in U.S. provisional patent application 61/451,978.

Disclosed embodiment have particular utility in that the use of supplied liquid coolants may be reduced or eliminated, replaced by the use of gas (for example, dry air). The gas may be supplied to the electromagnetic device from a tank or cylinder containing pressurized air, or the gas may be pressurized as needed by a compressor. The gas may be filtered for water or carbon dioxide or other contaminants as needed before it enters the electromagnet.

In an automotive application, for example, an automobile employing an electric drive might be recharged at a filling station with nitrogen at high pressure, and have the nitrogen circulate through the motor in liquid form in order to increase the power available from the electrical motors of the automobile. Alternatively a gas to be used as coolant according to the disclosed embodiments could be removed from the air by the automobile itself, and compressed in the automobile in order to supply the electromagnet in the motor. It should be understood that uses of the invention also extend to other types of vehicles, such as airplanes, surface and underwater sea vessels, whether manned or unmanned.

For the purpose of this disclosure, nitrogen has been used as an example of a liquefiable gas. However, other liquefiable gases may be suitable as a coolant, including nitrogen with intermixed gases (e.g., argon), argon, or carbon dioxide.

Alternatively, the electromagnet could be filled with liquid nitrogen that had been produced on site at the filling station or elsewhere. Currently, liquid nitrogen costs less than 40 cents per gallon, which is much less than gasoline. The liquid nitrogen could circulate as a coolant through the electromagnet and have the heat removed from the coolant in a separate device, or the heat could be removed in a section of the electromagnet that allowed expansion or evaporation of the liquid nitrogen. An attractive attribute of liquid nitrogen is that it has low viscosity (0.158 cP) as compared to other liquids (e.g., water, with a viscosity of 0.894 at room temperature).

Prior work by others has shown that electric motors can function very effectively (achieving a doubling in specific power) at liquid nitrogen temperatures, as pointed out in a 2007 NASA report by G Brown, R Jansen, and J Trudell, entitled “High Specific Power Motors in LN2 and LH2”(incorporated herein by reference in its entirety). In that report, coil windings were immersed in a bath of liquid nitrogen, unlike the present invention in which cooling channels are interspersed among the coil windings in order to achieve high efficiency coupling.

A calculation of the potential benefit for an electric or hybrid car can be seen as follows: Assuming a 10 kg mass of copper in a motor coil, with wire width of 1 mm and coil loops of approximately 10-cm width, a length of about 1 km of wire is used, having a resistance at room temperature of 17 ohms. Cooling the copper down to 77-degrees-K results in a resistance of about 2 ohms. If 100 amps is run through the coil, the ohmic losses are 170 kW at room temperature and 22 kW at the lower temperature. Keeping the coil at 77-degrees-K requires spending at least 22 kW on cooling the coil, and with inefficiencies of cooling, probably twice that much. However, the overall power loss (which affects the battery's ability to move the car) is still about half of what it would have been without cooling.

Nevertheless, it can be a challenge to maintain the low temperature of the cooled coil when there is physical contact to the outside world. It may, therefore, be beneficial to have the coil produce a rotating magnetic field which couples to a transmission, as is common on many cars today, and as described in a 2013 scholarly article entitled “Comparison of Magnetic-Geared Permanent Magnet Machines” (incorporated herein by reference in its entirety) by X Li, K-T Chau, M Cheng, and W Hua, in the journal Progress in Electromagnetics Research, vol. 133, pages 177-198.

Disclosed embodiments also have particular utility in that it is possible to generate higher magnetic fields with the electromagnet than would otherwise be possible using a given source of electrical current. This capability is particularly useful in a Magnetic Resonance Imaging (MRI) that operated without the need for liquid helium. It would also be useful in image-guided therapy, where a magnetic field for imaging may be switched rapidly with a means of delivering therapy. Such application is discussed in the U.S. patent application Ser. No. 13/586489, entitled “MRI-guided nanoparticle cancer therapy apparatus and methodology”, by I. N. Weinberg and P. Stepanov (incorporated herein by reference in its entirety.

Other applications where the disclosed embodiments may be useful include lowering the electrical resistance of inductive heaters. Inductive heaters work by running high currents to generate a magnetic field that induces heating of an electrically conductive (e.g., tungsten) or semiconductive (e.g., silicon) material through eddy currents in such material. Inductive heaters are thermally isolated from the substance they are heating (i.e., not in direct contact); therefore, they can be cooled to very low temperatures in order to lower their electrical resistance without compromising their ability to heat the material. Likewise, coils used to create, manipulate, and confine plasma are similarly thermally isolated from the plasma and would similarly benefit from cooling in order to lower their electrical resistance.

Another application of the disclosed embodiments may be in reducing the resistance of transformer coils. In voltage transformers, it is advantageous for the coils to have a high number of turns, since this improves the electromagnetic coupling between the two coils. Large number of turns means that the coil wire length is considerable and, therefore, prone to having large electrical resistances. Reducing the electrical resistance through cooling by used of the disclosed embodiments is advantageous.

Yet another application where the disclosed embodiments may be useful is mechanical actuation using a solenoid coil, as that found in loudspeakers, by virtue of lowering the resistance of the coil wire.

The apparatus may be constructed using flexible methods disclosed by I. N. Weinberg et al in U.S. application Ser. No. 13/242,386, entitled “Flexible methods of fabricating electromagnets and resulting electromagnet elements”. As an example, a paste may be extruded onto a substrate and cured by heat in situ in order to create a conducting path for electricity. Some or all of the conducting path may then be coated with a material, and the material may be cured in place to form an insulator. Examples of such materials include plastic, aluminum nitride, or diamond-like carbon, or diamond films. Cooling channels may be established in the part via overhanging or roof-like conductor/insulator structures. This process may be continued through additive manufacturing in order to build up an electromagnet.

While the present disclosure includes various disclosed embodiments, it should be evident that many alternatives, modifications and variations will be apparent to those skilled in the art. Accordingly, the various disclosed embodiments, as set forth above, are intended to be illustrative, not limiting. Various changes may be made without departing from the spirit and scope of the invention.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

As a result, it will be apparent for those skilled in the art that the illustrative embodiments described are only examples and that various modifications can be made within the scope of the invention as defined in the appended claims.

We claim:

1. A method of increasing the efficiency of an electromagnetic device, the method comprising:
transporting liquifiable gas through channels formed between electrical conductors in the device, and thereby cooling the electrical conductors to reduce their resistance to electrical current passing through the electrical conductors,
wherein the gas transforms from the gaseous to liquid state or from the liquid to gaseous state within the electromagnetic device.

2. The method of claim 1, wherein the electromagnetic device is a generator of magnetic fields for imaging.

3. The method of claim 1, wherein the electromagnetic device is a generator of magnetic fields for delivering therapy.

4. The method of claim 1, wherein the electromagnetic device is a generator of electrical current.

5. The method of claim 1, wherein the electromagnetic device is a transformer.

6. The method of claim 1, wherein the electromagnetic device is an inductor heater.

7. The method of claim 1, wherein the electromagnetic device is a device to confine or manipulate plasma.

8. The method of claim 1, wherein the electromagnetic device is a coil actuator.

9. The method of claim 1, wherein the electromagnetic device is a motor.

10. The method of claim 1, wherein the motor resides in an automotive vehicle.

11. The method of claim 10, wherein the automotive vehicle may be re-filled with compressed coolant gas at a station.

12. The method of claim 9, wherein the motor resides in an aerial vehicle.

13. The method of claim 9, wherein the motor resides in a maritime vehicle.

14. The method of claim 1, further comprising transmitting forces from the cooled electromagnetic conductors to other rotating parts through a magnetic gear drive.

15. The method of claim 1, wherein electrical insulators surround at least some of the electrical conductors.

16. An apparatus comprising:
electrical conductors; and
channels between the electrical conductors containing liquifiable gas coolant in both the gaseous and liquid state within the apparatus,
wherein the electrical conductors are in close proximity or direct contact with the channels containing liquefiable gas coolant.

17. The apparatus of claim 16, wherein the electromagnetic device is a generator of magnetic fields for imaging.

18. The apparatus of claim 16, wherein the electromagnetic device is a generator of magnetic fields for delivering therapy.

19. The apparatus of claim 16, wherein the electromagnetic device is a generator of electrical current.

20. The apparatus of claim 16, wherein the electromagnetic device is a transformer.

21. The apparatus of claim 16, wherein the electromagnetic device is an inductor heater.

22. The apparatus of claim 16, wherein the electromagnetic device is a device to confine or manipulate plasma.

23. The apparatus of claim 16, wherein the electromagnetic device is a coil actuator.

24. The apparatus of claim 16, wherein the electromagnetic device is a motor.

25. The apparatus of claim 16, wherein the motor resides in an automotive vehicle.

26. The apparatus of claim 25, wherein the automotive vehicle may be re-filled with compressed coolant gas at a station.

27. The apparatus of claim 24, wherein the motor resides in an aerial vehicle.

28. The apparatus of claim 24, wherein the motor resides in a maritime vehicle.

29. The apparatus of claim 16, further comprising transmitting forces from the cooled electromagnetic conductors to other rotating parts through a magnetic gear drive.

30. The apparatus of claim 16, wherein electrical insulators surround at least some of the electrical conductors.

31. A method of increasing the efficiency of an electromagnetic device, the method comprising:
flowing liquid nitrogen under pressure through channels formed between electrical conductors in the device, and thereby cooling the electrical conductors to reduce their resistance to electrical current passing through the electrical conductors.

32. The method of claim 31, wherein the electromagnetic device is a generator of magnetic fields for imaging.

33. The method of claim 31, wherein the electromagnetic device is a generator of magnetic fields for delivering therapy.

34. The method of claim 31, wherein the electromagnetic device is a generator of electrical current.

35. The method of claim 31, wherein the electromagnetic device is a transformer.

36. The method of claim 31, wherein the electromagnetic device is an inductor heater.

37. The method of claim 31, wherein the electromagnetic device is a device to confine or manipulate plasma.

38. The method of claim 31, wherein the electromagnetic device is a coil actuator.

39. The method of claim 31, wherein the electromagnetic device is a motor.

40. The method of claim 39, wherein the motor resides in an automotive vehicle.

41. The method of claim 40, wherein the automotive vehicle may be re-filled with compressed coolant gas at a station.

42. The method of claim 39, wherein the motor resides in an aerial vehicle.

43. The method of claim 39, wherein the motor resides in a maritime vehicle.

44. The method of claim 31, further comprising transmitting forces from the cooled electromagnetic conductors to other rotating parts through a magnetic gear drive.

45. The method of claim 31, wherein electrical insulators surround at least some of the electrical conductors.

46. An apparatus comprising:
electrical conductors; and
channels between the electrical conductors containing flowing liquid nitrogen,
wherein the electrical conductors are in close proximity or direct contact with the channels containing liquefiable gas coolant.

47. The apparatus of claim 46, wherein the apparatus is a generator of magnetic fields for imaging.

48. The apparatus of claim 46, wherein the apparatus is a generator of magnetic fields for delivering therapy.

49. The apparatus of claim 46, wherein the apparatus is a generator of electrical current.

50. The apparatus of claim 46, wherein the apparatus is a transformer.

51. The apparatus of claim 46, wherein the apparatus is an inductor heater.

52. The apparatus of claim 46, wherein the apparatus is a device to confine or manipulate plasma.

53. The apparatus of claim 46, wherein the apparatus is a coil actuator.

54. The apparatus of claim 46, wherein the apparatus is a motor.

55. The apparatus of claim 54, wherein the motor resides in an automotive vehicle.

56. The apparatus of claim 55, wherein the automotive vehicle may be re-filled with compressed coolant gas at a station.

57. The apparatus of claim 54, wherein the motor resides in an aerial vehicle.

58. The apparatus of claim 54, wherein the motor resides in a maritime vehicle.

59. The apparatus of claim 46, further comprising a magnetic gear through which forces from the cooled electromagnetic conductors are transmitted to other rotating parts.

60. The apparatus of claim 46, wherein electrical insulators surround at least some of the electrical conductors.

61. An apparatus in which electrical conductors, surrounded at least in part by insulating material, are in close proximity or direct contact with channels containing liquid nitrogen.

62. The apparatus of claim 61, wherein the apparatus is a generator of magnetic fields for imaging.

63. The apparatus of claim 61, wherein the apparatus is a generator of magnetic fields for delivering therapy.

64. The apparatus of claim 61, wherein the apparatus is a generator of electrical current.

65. The apparatus of claim 61, wherein the apparatus is a transformer.

66. The apparatus of claim 61, wherein the apparatus is an inductor heater.

67. The apparatus of claim 61, wherein the apparatus is a device to confine or manipulate plasma.

68. The apparatus of claim 61, wherein the apparatus is a coil actuator.

69. The apparatus of claim 61, wherein the apparatus is a motor.

70. The apparatus of claim 69, wherein the motor resides in an automotive vehicle.

71. The apparatus of claim 70, wherein the automotive vehicle may be re-filled with compressed coolant gas at a station.

72. The apparatus of claim 69, wherein the motor resides in an aerial vehicle.

73. The apparatus of claim 69, wherein the motor resides in a maritime vehicle.

74. The apparatus of claim 61, further comprising a magnetic gear through which forces from the cooled electromagnetic conductors are transmitted to other rotating parts.

75. The apparatus of claim 61, wherein electrical insulators surround at least some of the electrical conductors.

76. An apparatus in which forces are transmitted from the cooled electromagnet to other rotating parts through a magnetic gear drive.
